(19) United States
(12) Patent Application Publication
(10) Pub. No.: US 2025/0243043 A1
(43) Pub. Date: Jul. 31, 2025

(54) LIFTING BRIDGE, PARTICULARLY FOR MOTOR VEHICLES

(71) Applicant: O.ME.R. S.p.A., Mirano (IT)

(72) Inventor: Orietta ROSSATO, Mirano (IT)

(73) Assignee: O.ME.R. S.p.A., Mirano (IT)

(21) Appl. No.: 19/106,328

(22) PCT Filed: Sep. 4, 2023
(86) PCT No.: PCT/IB2023/058724

§ 371 Date: Feb. 25, 2025

(30) Foreign Application Priority Data
Sep. 12, 2022 (IT) 102022000018561

(51) Int. Cl. B66F 7/06

(52) U.S. Cl. CPC B66F 7/0691

(57) ABSTRACT

A motor vehicle lift includes at least one lane, two legs articulated thereto, each made of a single arm, at least one actuator associated with each leg and configured to vary the inclination of the leg with respect to the horizontal plane to cause lifting and lowering of the lane, and a synchronized control unit for the actuators. The legs connected to the lane are arranged symmetrically with respect to a transversal median plane of the lift. The lower end of each leg is articulated in correspondence with a first fixed transversal axis to a base for anchoring to a floor. The upper end of each leg is articulated in correspondence with a second transverse axis to a trolley sliding along the respective lane. Between at least leg of each lane and the section of lane which in the raised configuration forms an angle less than 90° with said leg.

### CROSS REFERENCE TO RELATED APPLICATIONS

This application is a § 371 National Phase of PCT/IB2023/058724, filed Sep. 4, 2023, which claims priority to Italian Patent Application No. 102022000018561, filed Sep. 12, 2022, the entire contents of all of which are incorporated by reference herein as if fully set forth.

### INVENTIVE FIELD

The present invention relates to a motor vehicle lift.

### BACKGROUND

Lifts for motor vehicles are known, comprising a pair of lanes, on which the motor vehicle to be lifted is raised, and two legs articulated above each lane and below to a base, which can consist of a side member anchored or resting on the floor or it can consist of the floor itself suitably configured and reinforced to support said legs in an articulated manner.

Each leg can consist of a single rigid element or arm, articulated below the base and above a rail, or by several rigid elements or arms, articulated with each other and also articulated below the base and above a rail.

The upward and downward movement of the two lanes is generally obtained with hydraulic actuators, placed between the legs and the lanes or between the legs and the base or between the articulated arms which form each leg.

A hydraulic power unit connected to the actuators provides for introducing the oil into these and discharging it from them and thus causing the synchronized upward and downward movement of the lanes with respect to the base.

There are various types of lifts: one of these, called “parallelogram” is described for example in U.S. Pat. No. 4,848,732. It comprises two base longitudinal members anchored or resting on the floor, two liftable lanes with respect to the basic longitudinal members and two or more pairs of legs, each made in a single element articulated below a base spar and above the corresponding lane.

In these lifts, the lifting of the lanes with respect to the side members is obtained with actuators placed between two homologous legs and the respective lanes. With the lengthening and shortening of the actuators following the introduction into them or the discharge from them of the hydraulic fluid, the angle formed between each leg and the lane varies, between which each actuator is placed, and this causes the deformation of the parallelogram formed by each spar, by the corresponding lane and by the two legs articulated to both and, consequently, causes the substantially translational movement of the lanes with a vertical component.

In lifts of this type the curve that represents the trend of the pressure of the hydraulic fluid in the actuators as a function of the lifting stroke of the lanes is decreasing, in the sense that the greater the height reached by the lanes, the lower the pressure of the fluid hydraulic system that keeps them raised and this is advantageous as the stresses on the actuators and on the mechanical safety locking devices of the raised lift are lower than those required when lifting the lift.

This type of lift has found wide diffusion due to its simplicity of construction and its operational reliability, but at the same time it has also highlighted some drawbacks and in particular:
a horizontal component of movement of the lanes during their lifting and the consequent overall dimensions of the raised lift significantly greater than that of the lowered lift, with the need to have a room larger than those required for the lifts for the installation of the lift, in which the lanes move with essentially vertical motion;
a footprint of the spars on the ground, which hinders the free passage of operators under the raised lift; this drawback can be overcome with the elimination of the longitudinal members and with the direct articulation of the legs to the floor, which in this case requires to be prepared for this installation, for example with the creation of a concrete beam embedded in the floor for the structural connection of the legs;
a limited maximum height that can be reached from the lanes due to the monolithic nature of the legs, which cannot be excessively long unless at the cost of negative structural and operational implications of the lift,
a hyperstatic behavior as each lifting jack is placed between a leg and the lane, which in practice has four or more constraint points.

Another known typology of lifts, described for example in U.S. Pat. No. 8,286,944, is characterized by having each leg formed by two arms of substantially equal length, articulated at one end to each other and at the other end to a base and the lane respectively corresponding. In these known lifts, in which the lanes move with substantially vertical motion, the hydraulic actuators for lifting the lanes are placed between the two arms of each leg, which moreover requires that these two arms are assisted by other articulated arms, having the function of making the leg-lane complex stable and of creating further support for the lanes, which in practice are supported by four points, i.e., two points for each leg.

In these known lifts, the positioning of the bases to which the legs are articulated requires a high degree of accuracy in order to allow the complete lifting of the lift and its complete lowering.

Furthermore, the support of each lane on four points implies a hyperstatic constraint, which in the case of deformation of the lanes or simply in the case of different heights from these reached following unbalances in the load or unbalances generated by the synchronization system of the actuators. causes hyperstatic forces to arise, which involve efforts linked to the constraints and deformations of the lift structure and only partially reduced by the elastic compensation system of the legs.

Another drawback consists in the fact that the curve which represents the trend of the pressure of the hydraulic fluid feeding the actuators as a function of the lifting stroke of the lanes is firstly decreasing until it reaches a minimum value, after which it begins to rise again until it practically reaches the high starting value when the lift is fully raised. This implies that the stresses on the actuators and on the mechanical safety locking devices of the lifted lift are maximum when the lift is lifted, i.e., it is in effective working conditions.

Other drawbacks of this known type of lift consist in a high manufacturing complexity, linked to the large number of components, which must necessarily be connected to each other and inevitably involve play and imprecision in their reciprocal movements.

Also known from EP 3995437 lifts for motor vehicles comprising a pair of rails each supported by a pair of legs placed symmetrically with respect to the transversal centerline plane of the lift. Each leg comprises a main rigid arm, which is articulated at the bottom to a base at a first fixed transversal axis and is articulated at the top to a track at a second transverse axis slidable longitudinally along this. Each leg further comprises an auxiliary arm articulated above the track at a third fixed transverse axis and articulated below the main arm at a fourth fixed transverse axis having the same distance from the second and third transverse axes. Each actuator for lifting the lift is interposed between the third transverse axis and a fifth transverse axis distinct from the fourth axis and fixed with respect to the main arm.

Drawbacks of this known lift consist in the hyperstatic connection of the lift lanes to the legs and in the large bulk of the legs along their length. Furthermore, these lifts also have other drawbacks already described in relation to the lift according to U.S. Pat. No. 8,286,944.

Finally, other lifts are also known with legs formed by two or more elements connected to each other with articulation systems which involve a non-vertical movement of the lanes and often a non-symmetrical arrangement of the legs with respect to the lanes, with reference to a transverse median plane of each lane; and this asymmetry in turn determines an asymmetrical behavior of the lanes with respect to the load.

### OBJECTIVES

The present invention aims to create a lift for motor vehicles which substantially eliminates all the drawbacks recognizable in the known types of lifts, whilst retaining the relevant advantageous aspects.

More specifically, an object of the invention is to create a lift in which the movement of the lanes occurs in a substantially vertical direction.

Another purpose of the invention is to create a lift, in which each leg is made of a single element articulated below the base and above a lane of the lift, and therefore presents a limited manufacturing complexity.

Another purpose of the invention is to create a lift capable of reaching a maximum height of the lanes equal to that achievable by current lifts which use legs formed by a single arm but having a greater overall length.

Another purpose of the invention is to create a lift capable of reaching a maximum height of the lanes equal to that achievable by current lifts which use legs made up of multiple articulated arms.

Another object of the invention is to provide a lift, in which the support of the rails to the legs is of the isostatic type, with the elimination of stresses linked to the constraints and deformations of the lift structure.

Another object of the invention is to create a lift that does not hinder the free passage of the operators underneath the raised lift.

Another purpose of the invention is to create a lifting which has a dissipative behavior in the event of seismic events.

Another purpose of the invention is to create a lift capable of reducing the deformations and structural stresses that arise on the lanes as the lift is raised.

### SUMMARY

All these purposes and others that will result from the following description are jointly or severally achieved according to the invention with a lift for motor vehicles as defined below.

### BRIEF DESCRIPTION OF THE DRAWINGS

The present invention is further clarified below in some of its preferred practical embodiments reported for purely illustrative and non-limiting purposes with reference to the attached drawings, in which:

FIG. 1 schematically shows a perspective view of a lift according to the invention in a first embodiment and in a raised condition,

FIG. 2 always shows it in perspective view but in a lowered condition,

FIG. 3 shows an enlarged side view of the right side of the lift in the raised condition with the lane partially sectioned,

FIG. 4 shows it according to the vertical section IV-IV of FIG. 3,

FIG. 5 shows it in the same view as FIG. 4 but in lowered condition,

FIG. 6 shows it in the same view as FIG. 3 in a variant construction,

FIG. 7 shows a particular embodiment of a component of the lift in FIG. 6,

FIG. 8 shows a different embodiment of the same component,

FIG. 9 shows it in another embodiment of the same component,

FIG. 10 shows the lift according to the invention in a different configuration that uses the same principles already described with reference to the previous embodiments illustrated in the previous figures, and

FIG. 11 shows on a larger scale the right side of a lift in this different configuration but in a different embodiment.

### DETAILED DESCRIPTION OF THE PREFERRED EMBODIMENTS

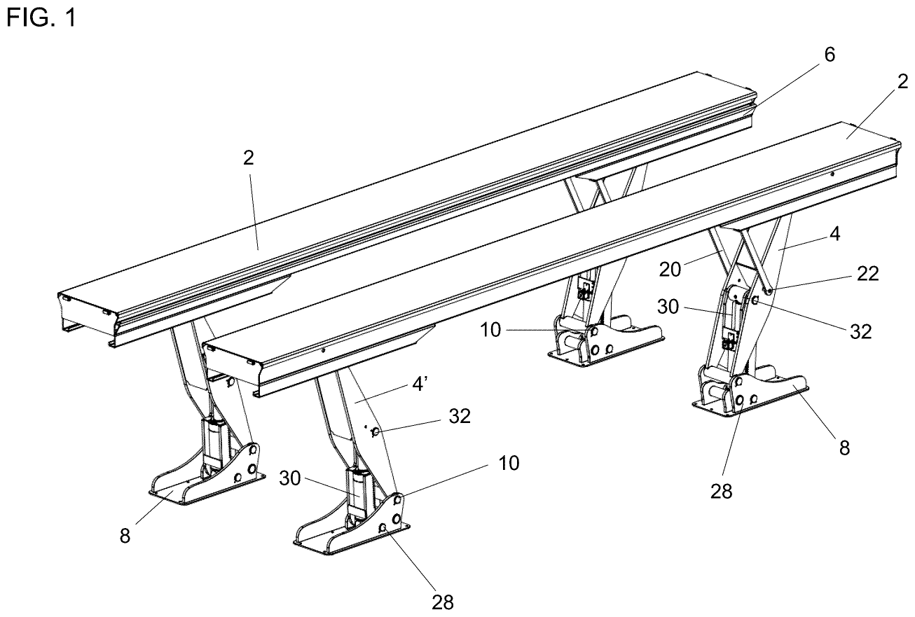

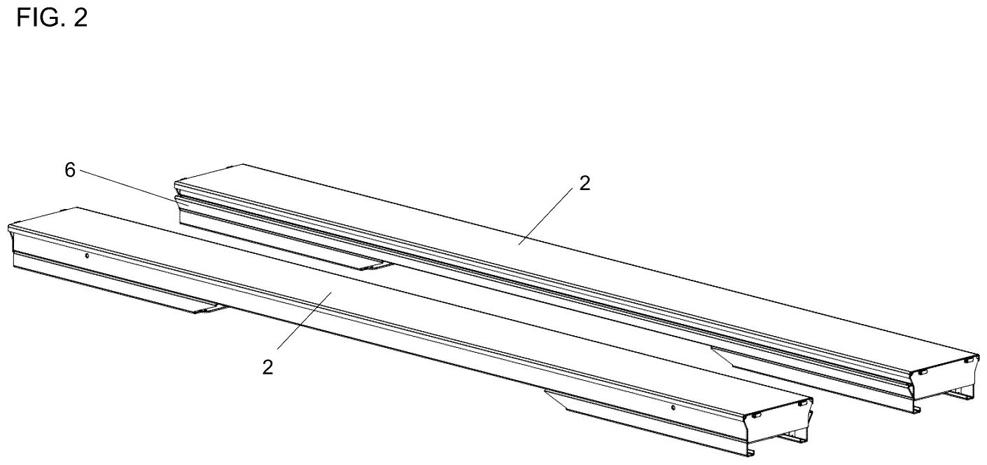

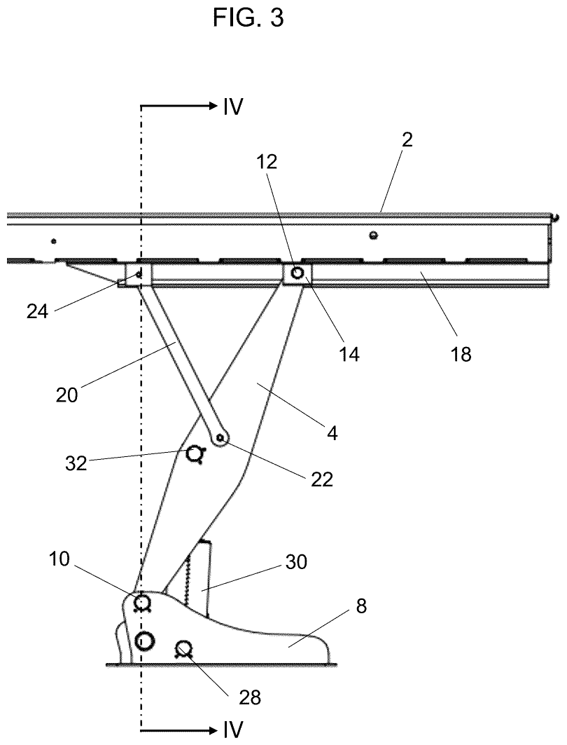

As can be seen in FIGS. 1-5, the lift according to the invention includes two lanes 2, intended to accommodate a motor vehicle or in any case the load to be lifted, and two pairs of legs 4,4′, each formed by a single configured and sized element based on the specific stresses resulting from the project. Preferably each leg 4,4′ is formed by sheet metal plates of suitable shape and thickness, welded together so as to define a box-shaped element capable of effectively resisting the bending and torsional stresses typical of lifts, in particular when they are stressed by eccentric loads, which can arise when the lifts are equipped with auxiliary crosspieces connecting the lanes, which weigh mainly on the inner edge of the same. Indeed, for this purpose it can be advantageously provided that the lanes 2 have a profile such as to highlight a longitudinal rail 6, useful for supporting these auxiliary crosspieces (not shown as they are traditional in themselves), which are often required to facilitate the work of the operators on the vehicle placed on the lanes of the raised lift.

Each leg 4,4′ is articulated below to a base 8, preferably anchored to the floor, and is articulated above the corresponding lane 2. However, while the lower articulation of each leg 4,4′ to the relevant base 8 occurs at a fixed transverse axis 10 (first articulation axis), the upper articulation of each leg 4,4′ to the relevant lane 2 occurs in correspondence with an articulation axis 12 (second articulation axis), located in a sliding carriage 14 preferably with bearings 16 along longitudinal channels 18, obtained in lane 2.

In the embodiment illustrated in FIGS. 1-5 a leg 4 of each lane 2 is provided with a rigid rod 20 or preferably with two rigid rods 20, articulated at one end to the two sides of the leg 4 and at the other end to the section of lane 2 which forms with leg 4 an angle less than 90°.

The articulation of the rod 20 or of each rod 20 to the leg 4 is obtained in correspondence with a fixed transverse axis 22 (third articulation axis), which preferably lies on the plane passing through the first articulation axis 10 and the second axis of articulation 12. The articulation of each rod 20 to the lane 2 is obtained in correspondence with a fixed transverse axis 24 (fourth articulation axis), advantageously chosen so that the distance between the two axes 22 and 24 is equal to the distance between the two axes 22 and 12.

More particularly, the connection between each rod 20 and the legs 4,4′ is obtained with the interposition of a shock-absorbing bush, which in practice consists of a tubular sleeve 26 made of elastic material, in particular a compact rubber of the NBR or SBR type vulcanized or pressed onto metal elements, and placed between an internal pin integral with each leg 4,4′ and having a longitudinal axis coinciding with the third articulation axis 22, and a hollow cylindrical body integral with the end of the rod 20. In this way the articulation between the rod 20 and the respective leg 4,4′ are of the cushioned type, in the sense that it allows limited elastic movements of the rod 20 orthogonally to its axis 22 of articulation to the leg 4,4′ in both directions.

However, in conditions of substantially unstressed bushing 26, the distance between the third articulation axis 22 and the second articulation axis 12 is substantially equal to the distance between the third articulation axis 22 and the fourth articulation axis 24.

The same result can however be obtained if the shock-absorbing bush was placed in the connection between the rod 20 and the lane 2, or even, even more so, in both connections between the rod 20, the leg 4,4′ and the lane 2.

Preferably the third articulation axis 22 is also equidistant from the first articulation axis 10 and from the second articulation axis 12.

Also articulated to each base 8, in correspondence with a fixed transverse axis 28 (fifth articulation axis), distinct from the axis 10, is an actuator 30, preferably of the hydraulic type, which is constituted by a jack, having an articulated stem to the respective leg 4,4′ in correspondence with a transverse axis 32 (sixth axis of articulation), preferably located approximately in the central area of the leg itself. The two actuators 30 applied to the two legs 4,4′ are connected to a power supply and control unit (not shown) and are synchronized with each other in their movements with flow dividers or with electronic systems, which in themselves are traditional and not are further described. However, it is also envisaged that not one but two side-by-side actuators 30 can be applied to the same leg 4,4′, obviously synchronized in their movements.

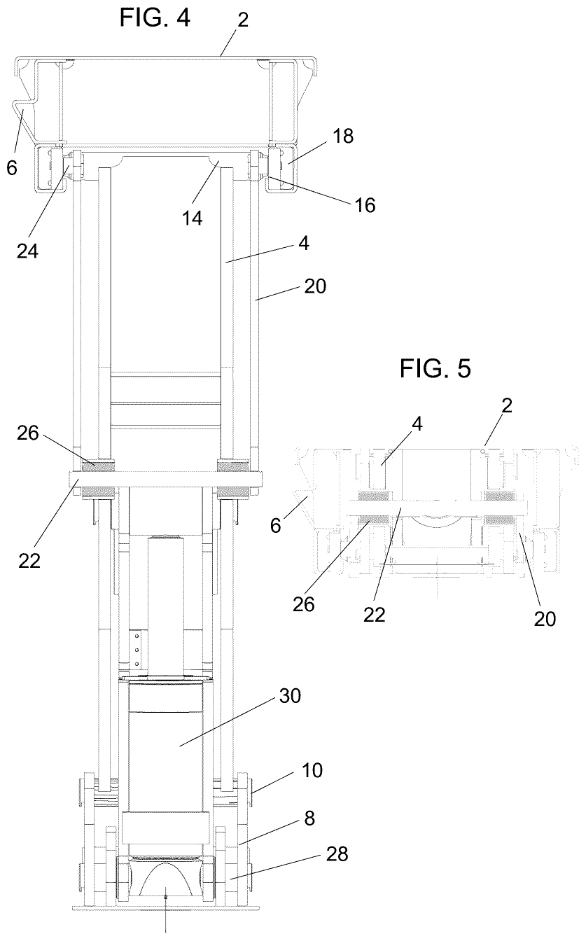

The shape and dimensions of the legs 4,4′ of the lanes 2 and of the bases 8 are preferably such that when each lane 2 is in the completely lowered position, practically resting on the floor, it houses the bases 8, the legs 4,4′, the actuators 18 and the rods 22, as can be seen from the comparison between FIG. 4 and FIG. 5.

Furthermore, the geometry of the lift is such that the fifth articulation axis 28 of the actuator 30 at the base 8 is placed at a lower level than the first articulation axis 10 of the leg 4, 4′ at the base 8; and that in the condition of the lift fully lowered, the second articulation axis 12 of each leg 4, 4′ to the respective carriage 14 is at a level no higher than that of the first articulation axis 10 of the leg itself at the base 8, and the articulation axis 32 of the actuator 30 at the leg 4,4′ is at a level not lower than that of the articulation axis 28 of the actuator itself at the base 8.

Furthermore, always when each track 2 is in its lowest position, the sixth axis of articulation 32 of each actuator 30 to the relative leg 4,4′ is preferably located at a higher level than the axis of articulation 28 of the actuator 30 to the base 8.

The operation of the lift according to the invention in the embodiment now described can be better understood if we first distinguish the case of the lift loaded with a motor vehicle in a balanced manner and the case of the lift loaded with a motor vehicle in an unbalanced manner, for example with the front part of the vehicle is heavier than the rear part.

In the ideal case of a perfectly balanced load and a synchronization system of the lifting actuators 30 without tolerances, during the lifting of the lift the lanes 2 move with a purely vertical translational motion and remain perfectly centered in the longitudinal direction with respect to the legs 4,4 ‘.

In practical cases, however, the load is almost always unbalanced and the synchronization system of the actuators 30 always presents inevitable intervention tolerances. If in these conditions the lanes 2 were simply connected to the legs 4,4’ via the trolleys 14, the inevitable greater deformation of the most heavily loaded leg and its different inclination with respect to the other leg would cause the uncontrolled sliding of each lane 2 with respect to its legs 4,4′ to an extent permitted by the degrees of freedom of the system and in a direction consistent with the movement of the upper end of the leg 4 or 4′, which at that moment presents greater friction with lane 2, regardless of the greater or lesser load on that leg.

The presence, however, between each lane 2 and the respective legs 4,4′ of this further constraint constituted by the rod 20 or the rods 20 means that if, for example, due to an imbalance in the load one of its legs 4 or 4′ of each lane 2 is less inclined than the other leg, a control of the longitudinal sliding of lane 2 is implemented, in the sense that this sliding always occurs towards the less inclined leg 4 or 4′ and is of an extent linked to the geometry of the system.

In this way it is possible to obtain, with a rather simple lift configuration and safe and reliable operation, a series of advantages which previously could not be obtained with traditional lifts.

One of the advantages consists in the possibility of controlling the movements of each lane 2 of the lift with respect to its legs 4,4′ according to a defined motion law linked to the geometry of the system according to the different inclination of the latter with respect to the horizontal.

Another advantage consists in the fact that the support of each lane 4,4′ on the legs 2 occurs at only two points and therefore constitutes an isostatic constraint which excludes the onset of stresses linked to constraints and deformations of the structure.

Another advantage consists in the fact that the arrangement of the legs 4,4′ with respect to the lanes 2 means that the two supports of each lane 2 on the two legs 4,4′ become increasingly closer to each other as the lift rises and this reduces the inevitable bending deformations of the lanes under load in the raised lift condition.

Another advantage consists in the fact that the curve which represents the trend of the pressure of the hydraulic fluid in the actuators 18 as a function of the lifting stroke of the lanes 2 is decreasing, with all the beneficial effects in terms of stresses on the actuators 18 and on the control devices mechanical safety of the raised lift, always present.

Another advantage is that there are no obstacles for operators below the raised lift.

Another advantage consists in the fact that in the case of seismic events the energy imparted to the lift is partially dissipated by the elastic deformation of the cushioned connection between each leg 4,4′ and the lane 2, obtained through the rod 20.

Another advantage consists in the fact that the greater height of the articulation axis 10 of the legs 4,4′ at the respective bases 8 compared to the articulation axis 12 of the legs themselves at the lanes 2 when the lift is lowered allows the use of the entire length of the legs 4,4′ and therefore to use legs of shorter length with the same overall dimensions of the lowered lift and with the same maximum height reachable from the lanes 2. In particular, with the lift according to the invention it is possible to obtain a ratio between the vertical lifting stroke of the lanes 2 and the length of the legs 4,4′ (measured with reference to the articulation axes 10 and 12) close to or even greater than unity, unlike traditional lifts, in which this value is clearly less than unity, both if they have legs made up of a single arm and if they have legs made up of articulated arms and the length of the leg is considered to be the sum of the lengths of the two arms that form it.

It should be noted that the load differences affecting the support points of the lanes 2 at the legs 4,4′ when the lift is raised and which are generally due to various causes, such as in particular the uneven distribution of weights in the lifted vehicle, the behavior differences of the safety devices, the hydraulic power supply tolerances, the pressure differences on the various jacks and the consequent elongation differences of these, the power supply tolerances, would tend to alter the geometry of the lift and to arrange in a different way its two lanes 2, in contrast with the reaction of the motor vehicle which is placed on them in a braked condition and which tends with its presence to prevent relative movements between them according to the axis of the lanes.

If this tendency to alter the geometry of the lift remains below a certain extent, linked to the construction characteristics of the lift, it can be absorbed by the contact between the tires of the vehicle and the lanes, by the deformability and by the play of the lift itself. However, since in practice this tendency can go beyond the absorption capacity of the deformability and play of the lift itself, the invention envisages overcoming it with the adoption of shock-absorbing sleeves 26, which in practice allow absorption with their elastic deformation the difference in distance that is generated between the third articulation axis 22 rod/leg and the second articulation axis 12 leg/trolley compared to the distance between the third articulation axis 22 rod/leg and the fourth articulation axis 24 rod/lane.

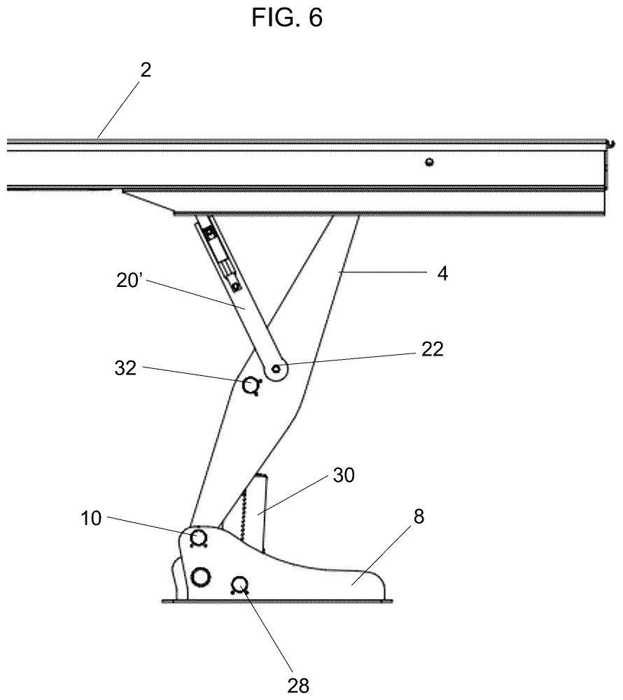

As an alternative to shock-absorbing sleeves, the invention involves the use of 20′ or 20″ rods with controlled variable length, as illustrated schematically in FIG. 6.

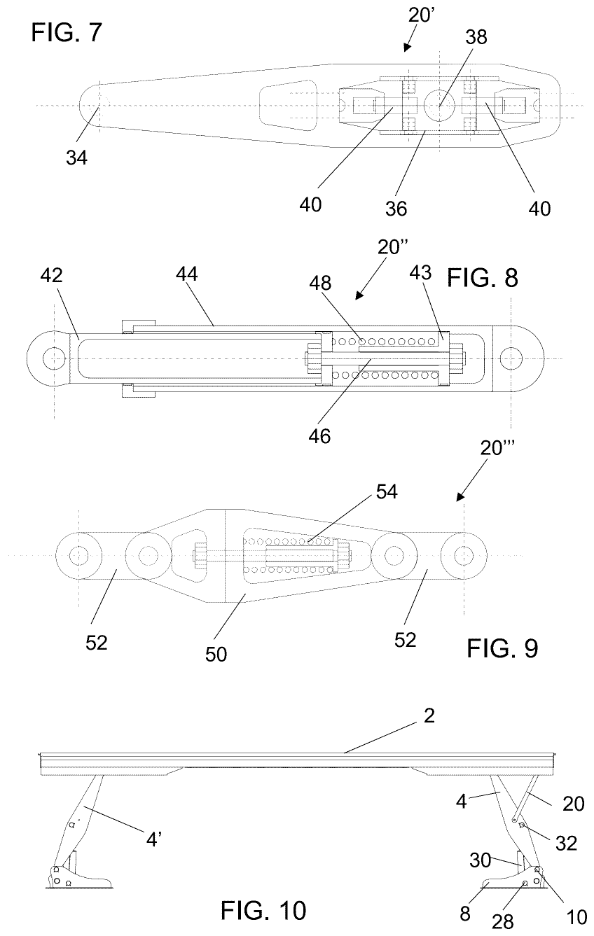

In FIG. 7 illustrates in greater detail an embodiment of a rod 20′ with controlled variable length. It is provided at one end with a circular opening 34 for the articulated constraint to the lane 2 in correspondence with the fourth articulation axis 24, and is provided near the other end with a slide 36 which slides longitudinally along the rod 20′ and equipped with a circular opening 38 for the articulated constraint to the leg 4,4′ in correspondence with the third articulation axis 22.

The slide 36 is placed between two elastic contrast elements 40 pre-loaded with compression, which in themselves are traditional, can be made up of metal springs or air springs or hydraulic springs and act on the slide itself in opposite directions to keep it elastically centered in the its rest position but at the same time allow its limited movements in one or the other direction depending on the tendency of the lanes to assume a differentiated position.

In FIG. 8 shows another embodiment of the 20″ rod with controlled variable length, which includes two telescopic elements 42,44, which can be articulated with the external end to the lane 2 and to the leg 4,4′. Between the internal circular base of the element 42 and a circular flange 43 fixed to it by a tie rod 46 axially mobile with respect to the element 42, a spring 48 is interposed, pre-loaded for compression in an adjustable manner with screw means applied to the tie rod itself.

If the rod 20″ is stressed by traction, it elongates following the mutual sliding of the two elements 42,44 without opposing any reaction, while if it is stressed by axial compression, it reacts elastically following the support of the flange 43 associated with the element 42 against a circumferential step formed in the internal wall of element 44.

In FIG. 9 shows another embodiment of the rod 20′″, which includes an elongated central body 50, at the ends of which two connecting rods 52 are articulated for articulating the rod 20′″ to the lane 2 in correspondence with the fourth axis 24 and to the leg 4,4′ in correspondence with the third axis 22. The central body 50 is formed by two parts coupled together in correspondence with flat surfaces and held in that condition by a spring 54 preloaded by compression. This 20′″ rod works exclusively by traction, and in this case the spring 54 is further compressed allowing the temporary mutual distancing of the two parts of the central body 50. However, if the 20″ rod is subjected to compression, it does not react to this type of stress but is arranged with the two connecting rods 52 angled with respect to the central body 50.

Naturally, the choice of the particular type of rod 20,20′,20″ or 20′″ and its constructive and functional characteristics, which allow it to have bidirectional reactions (FIG. 4, and FIG. 7) or unidirectional (FIGS. 8 and 9), affect the number and position of the rods in the lift. In particular, if the rods are of the bidirectional type, such as the rods 20, 20′, they can be mounted on the same leg 4 and/or 4′ for each lane 2, while if the rods are of the unidirectional type, such as the rods 20″, 20′″ they must be mounted on both 4, 4′ legs of each lane 2.

In FIG. 10 shows a lift in this different embodiment, which uses rigid rods 22 fixed to the legs and to the lanes by shock-absorbing bushings; however, the same lift configuration could use controlled variable length rods of the bidirectional 20′ or unidirectional 20″ and 20′″ type, as previously described.

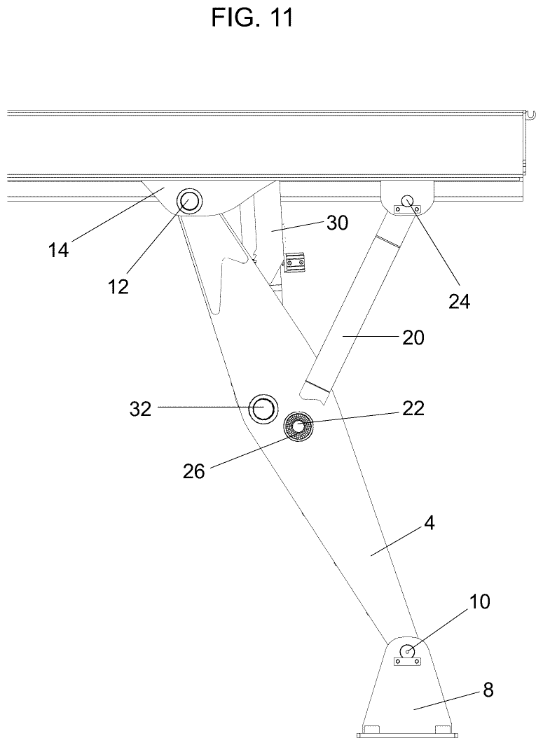

The embodiment illustrated in FIG. 11 uses the same principles already described for the previous embodiments, from which it essentially differs in that it has the actuators 30 which instead of being interposed between the legs 4, 4′ and the respective bases 8, are interposed between the legs 4, 4′ and the respective carriages 14 sliding along the lanes 2.

In addition to presenting all the advantages already described in relation to the previous embodiments, this last embodiment presents the further advantage of having all the components of the lift, which for different reasons can be considered critical, namely the actuators 30, the mechanical, electrical and electronic control safety devices, which are generally associated with the actuators 30, and the connections between these and the power and control units, located in the upper part of the lift and this means that during use of the lift they are kept distanced from the floor and are in this way more protected from dirt (polluting materials, washing liquids, etc.) which are generally predominantly present on the floor or near it.

1. A lift for motor vehicles, the lift comprising:
at least one lane,
two legs articulated to said at least one lane each leg comprised of a single arm,
at least one actuator associated with each leg and configured to vary inclination of the legs with respect to the horizontal plane and to lift and lower said at least one lane, and
a synchronized control unit for the at least one actuator, wherein
the two legs connected to said at least one lane are arranged symmetrically with respect to a transversal median plane of the lift,
a lower end of each leg is articulated in correspondence with a first fixed transversal axis to a base for anchoring to a floor,
an upper end of each leg is articulated in correspondence with a second transverse axis to a trolley sliding along a respective lane,
between at least one of the two legs of the at least one lane and the section of at least one lane which in the raised lift configuration forms an angle less than 90° with said leg, a further connection is provided comprising at least one rod articulated at one end to said leg in correspondence with a third transverse axis and at the other end to said lane in correspondence of a fourth fixed transversal axis,
said at least one rod is provided with elastic means configured to absorb variations in distance between said third axis and fourth axis of articulation of the rod to said leg and said at least one lane, resulting from changes in the geometry of the lift which are due to load imbalances or to the functioning of the lift and are counteracted by the presence of a vehicle placed on a raised at least one lane.

2. The lift according to claim 1, wherein a distance between the upper ends of said legs is less than a distance between the lower ends of the legs in any lifting condition of the lift.

3. The lift according to claim 1, wherein a distance between the upper ends of said legs is greater than a distance between the lower ends of the legs in any lift condition of the lift.

4. The lift according to claim 1, wherein the distance between said third articulation axis and said fourth articulation axis is equal to the distance between said third articulation axis and said second articulation axis.

5. The lift according to claim 1, wherein said at least one rod is substantially rigid and is articulated to said leg and/or to said at least one lane by means of a shock-absorbing sleeve.

6. The lift according to claim 5, wherein said shock-absorbing sleeve is made of elastic material and is placed between an internal pin integral with said leg and/or with said at least one lane and a hollow cylindrical body integral with the corresponding end of said rod.

7. The lift according to claim 1, wherein said rod is of the controlled variable length type.

8. The lift according to claim 7, wherein said rod includes a body affected at one end by means for articulated constraint to said at least one lane or to said leg, a slide sliding along said body and affected by means for articulated constraint to said leg or to said lane, and pre-loaded elastic means cooperating with said slide to counteract said slide's movements from a predefined rest position.

9. The lift according to claim 7, wherein said rod includes two telescopically sliding elements, between which elastic means are interposed, pre-loaded with compression and bias to exclusively counteract the shortening telescopic of the rod.

10. The lift according to claim 7, wherein said rod includes several parts articulated together and associated with elastic means pre-loaded by compression, which keep the parts in a substantially aligned condition.

11. The lift according to claim 8, wherein said pre-loaded elastic means are made up of metal springs or air springs or hydraulic springs.

12. The lift according to claim 1, wherein in a lowered lift configuration, said first articulation axis of said leg to said base is placed at a level not lower than said second articulation axis of said leg to said trolley.

13. The lift according to claim 1, wherein said at least one actuator is placed between said leg and the relative base.

14. The lift according to claim 1, wherein in a lowered lift configuration, a sixth articulation axis of said actuator to the relevant leg is placed at a level not lower than a fifth articulation axis of the actuator to the relative base.

15. The lift according to claim 1, wherein said at least one actuator is placed between each leg and the trolley sliding along the respective at least one lane.

16. The lift according to claim 1, wherein in a lowered lift configuration said at least one lane houses within it the respective legs, the actuators associated with them, the rods and the bases, to which said legs are articulated.

17. The lift according to claim 1, wherein a ratio between the maximum lifting stroke of said at least one lane, measured with reference to said second articulation axes to a respective trolleys, and the length of said legs, measured between said second articulation axes to the respective carriages and said first articulation axes to the respective bases, is not less than unity.

18. The lift according to claim 1, wherein the at least one lane is two lanes, each supported by two legs.

19. The lift according to claim 18, wherein each lane is configured in such a way as to present, at least in correspondence with its internal longitudinal edge, a continuous longitudinal step for supporting internal crosspieces.

20. The lift according to claim 1, wherein the at least one lane is a single lane, to which a plurality of crosspieces projecting laterally from both sides of the lane are applied and wherein the crosspieces are configured to support a motor vehicle.
